(19) United States
(12) Patent Application Publication
(10) Pub. No.: US 2016/0088298 A1
(43) Pub. Date: Mar. 24, 2016

(54) VIDEO CODING RATE CONTROL INCLUDING TARGET BITRATE AND QUALITY CONTROL

(71) Applicants: XIMIN ZHANG, San Jose, CA (US); SANG-HEE LEE, Santa Clara, CA (US)

(72) Inventors: XIMIN ZHANG, San Jose, CA (US); SANG-HEE LEE, Santa Clara, CA (US)

(21) Appl. No.: 14/492,915

(22) Filed: Sep. 22, 2014

(51) Int. Cl. H04N 19/124; H04N 19/91; H04N 19/136; H04N 19/159; H04N 19/146; H04N 19/176

(52) U.S. Cl. CPC H04N 19/124; H04N 19/146; H04N 19/176; H04N 19/136; H04N 19/159; H04N 19/91

(57) ABSTRACT

Systems, apparatus and methods are described including operations for video coding rate control including target bitrate and quality control.

### BACKGROUND

A video encoder compresses video information so that more information can be sent over a given bandwidth. The compressed signal may then be transmitted to a receiver that decodes or decompresses the signal prior to display.

Rate control often used to control the number of generated bits for various video applications. Usually, the application provides a target bit rate and buffer constraint to the rate control module. The rate control module may use this information to control the encoding process such that target bit rate is met and buffer constraint is not violated.

Such a target bit rate oriented approach may waste bits when the video quality is already very good. In order to solve this problem, one solution is to use a constant minimum quantization parameter (QP) to cap the QP generated by the rate control module.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example video coding system;

FIG. 2 is a flow chart illustrating an example target bitrate and quality control subsystem;

FIG. 3 is an illustrative diagram of an example quality oriented picture QP calculation portion of a target bitrate and quality control subsystem;

FIG. 4 is an illustrative diagram of an example HVS based block QP map generation portion of a target bitrate and quality control subsystem;

FIG. 5 is a flow diagram illustrating an example coding process;

FIG. 6 illustrates an example bitstream;

FIG. 7 is a flow diagram illustrating an example decoding process;

FIG. 8 provides an illustrative diagram of an example video coding system and video coding process in operation;

FIG. 9 is an illustrative diagram of an example video coding system;

FIG. 10 is an illustrative diagram of an example system; and

FIG. 11 is an illustrative diagram of an example system, all arranged in accordance with at least some implementations of the present disclosure.

### DETAILED DESCRIPTION

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for video coding rate control including target bitrate and quality control.

As described above, target bit rate oriented approaches may waste bits when the video quality is already very good. In order to solve this problem, one solution is to use a constant minimum quantization parameter (QP) to cap the QP generated by the rate control module. However, this approach does not consider the characteristics of human visual system (HVS). Accordingly, such target bit rate oriented approaches cannot effectively adapt to the contents of the video such as texture and motion. As the result, such target bit rate oriented approaches may waste too many bits on some area and cause worse quality in some other areas.

The implementations discussed below were aimed to develop a low complexity method to achieve target subjective quality, satisfy the target bit rate and buffer constraint and prevent waste of bits at the same time. With the provided target quality, picture level analysis may be used to generate the picture level QP. Based on a Human Visual System Model (HVS) based texture and motion analysis, a block level QP map is then generated such that the HVS sensitive area use smaller QP and less sensitive area use bigger QP. Finally, the block level QP map may be used to adjust the rate control generated QP to obtain the final QP for the encoding process.

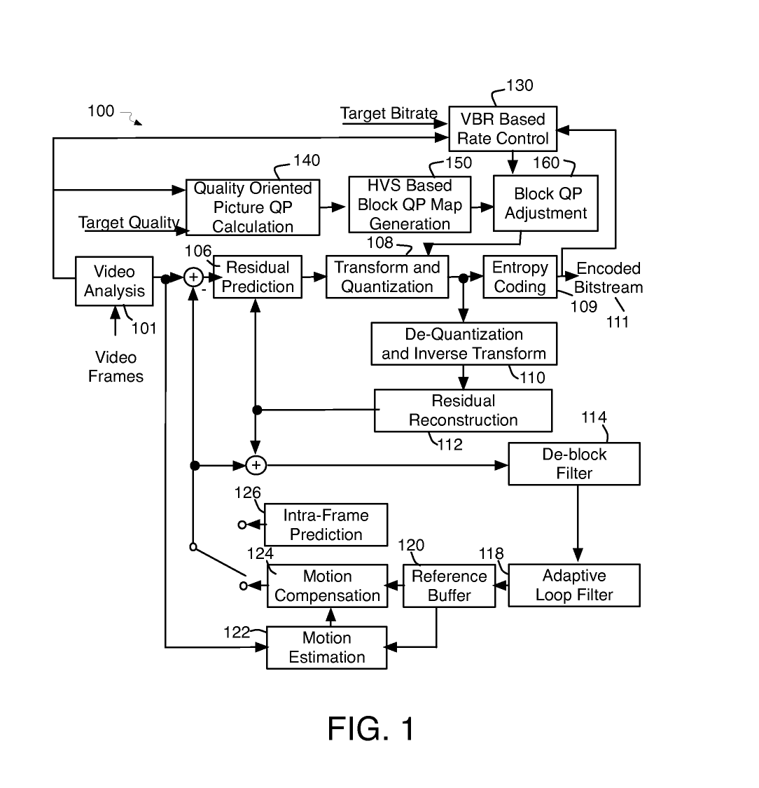

FIG. 1 is an illustrative diagram of an example video coding system 100, arranged in accordance with at least some implementations of the present disclosure. In various implementations, video coding system 100 may be configured to undertake video coding and/or implement video codecs according to one or more advanced video codec standards, such as, for example, the High Efficiency Video Coding (HEVC) H.265 video compression standard, but is not limited in this regard. Further, in various embodiments, video coding system 100 may be implemented as part of an image processor, video processor, and/or media processor.

As used herein, the term “coder” may refer to an encoder and/or a decoder. Similarly, as used herein, the term “coding” may refer to encoding via an encoder and/or decoding via a decoder. For example video encoder 103 and video decoder 105 may both be examples of coders capable of coding.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic, etc. that have not been shown in FIG. 1 for the sake of clarity.

In some examples, during the operation of video coding system 100, current video information may be provided to a video analysis module 101 in the form of a frame of video data. The current video frame may be analyzed (e.g., the frame type and/or hierarchical dependency might be determined at this stage) and then passed to a residual prediction module 106. The output of residual prediction module 106 may be subjected to known video transform and quantization processes by a transform and quantization module 108. The output of transform and quantization module 108 may be provided to an entropy coding module 109 and to a de-quantization and inverse transform module 110. Entropy coding module 109 may output an entropy encoded bitstream 111 for communication to a corresponding decoder.

Within the internal decoding loop of video coding system 100, de-quantization and inverse transform module 110 may implement the inverse of the operations undertaken by transform and quantization module 108 to provide the output of residual prediction module 106 to a residual reconstruction module 112. Those skilled in the art may recognize that transform and quantization modules and de-quantization and inverse transform modules as described herein may employ scaling techniques. The output of residual reconstruction module 112 may be fed back to residual prediction module 106 and may also be provided to a loop including a de-blocking filter 114, an adaptive loop filter 118 (and/or other filters), a buffer 120, a motion estimation module 122, a motion compensation module 124 and an intra-frame prediction module 126. As shown in FIG. 1, the output of either motion compensation module 124 or intra-frame prediction module 126 is both combined with the output of residual prediction module 106 as input to de-blocking filter 114, and is differenced with the original video frames input to residual prediction module 106.

As will be explained in greater detail below, in some examples, video coding system 100 may further include a VBR based rate control module 130, a quality oriented picture QP calculation module 140, an HVS based block QP Map generation module 150, and/or a block QP adjustment module 160. In some implementations, VBR based rate control module 130 may be configured to determine an estimated QP at a block level based at least in part on a target bitrate. Quality oriented picture QP calculation module 140 may be configured to determine a target QP at a picture level based at least in part on a target quality factor. HVS based block QP Map generation module 150 may be configured to determine a target QP at a block level based at least in part on a target quality factor (e.g., as a refinement of the determined coarse target QP at a picture level). Block QP adjustment module 160 may determine a final QP at a block level based at least in part on the determined estimated QP and the determined target QP. The final QP at a block level may be utilized by transform and quantization module 108 during quantization.

The implementations discussed below were aimed to develop a low complexity method to achieve target subjective quality, satisfy the target bit rate and buffer constraint and prevent waste of bits at the same time. With the provided target quality, picture level analysis may be used to generate the picture level QP. Based on a Human Visual System Model (HVS) based texture and motion analysis, a block level QP map is then generated such that the HVS sensitive are a use smaller QP and less sensitive area use bigger QP. Finally, the block level QP map may be used to adjust the rate control generated QP to obtain the final QP for the encoding process.

Additionally or alternatively, the methods and/or systems discussed herein might be integrated into Advanced Video Coding (AVC), High Efficiency Video Coding (HEVC), VP8 video compression format, VP9 video compression format, the like, and/or other video codec solutions.

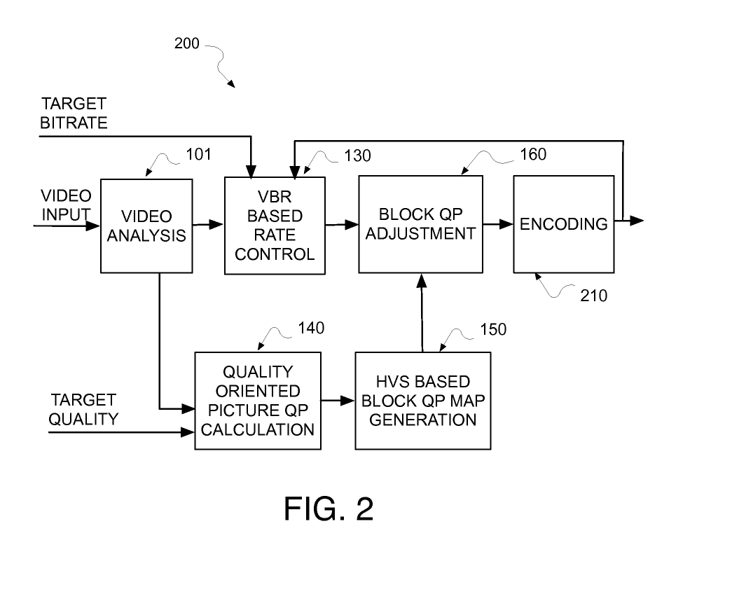

As will be discussed in greater detail below, video coding system 100 may be used to perform some or all of the various functions discussed below in connection with FIGS. 2-8.

FIG. 2 is a diagram illustrating an example target bitrate and quality control subsystem 200, arranged in accordance with at least some implementations of the present disclosure. In the illustrated implementation, target bitrate and quality control subsystem 200 may include one or more modules, functions or actions as illustrated by one or more of blocks 101 etc. By way of non-limiting example, target bitrate and quality control subsystem 200 will be described herein with reference to example video coding system 100 of FIGS. 1 and/or 9.

In the illustrated implementation, target bitrate and quality control subsystem 200 may include one or more modules. As discussed above, in some examples, target bitrate and quality control subsystem 200 may include VBR based rate control module 130, quality oriented picture QP calculation module 140, HVS based block QP Map generation module 150, and/or block QP adjustment module 160.

In some implementations, VBR based rate control module 130 may be configured to determine an estimated QP at a block level based at least in part on a target bitrate. For example, in the beginning of the encoding, video analysis may be conducted to provide necessary information for VBR based rate control. Based on the analysis, target bit rate, buffer fullness and instant encoding information, VBR rate control may generate an estimated QP for each coding block of the current frame. For VBR based rate control module 130, any method which is capable of achieving target bit rate and satisfying the buffer constraints can be used here.

In some implementations, quality oriented picture QP calculation module 140 may be configured to determine a target QP at a picture level based at least in part on a target quality factor. For example, at the same time of VBR rate control process, a target picture level QP may be derived in quality oriented picture QP calculation module 140 based on video analysis information and target quality.

In some implementations, HVS based block QP Map generation module 150 may be configured to determine a target QP at a block level based at least in part on a target quality factor (e.g., as a refinement of the determined coarse target QP at a picture level). For example, on top of the target picture level QP, block QP map is generated according to the HVS based analysis to provide a target QP at a block level (e.g., a target QP for each coding block).

In some implementations, block QP adjustment module 160 may determine a final QP at a block level based at least in part on the estimated QP and the determined target QP. For example, after the block QP map is generated, the VBR derived QP is adjusted according to the target QP for each block. The adjusted final QP will be sent to the encoder and used for the mode decision and final quantization process.

In one implementation, the VBR derived estimated QP may be lower capped by the target QP. That means if the VBR derived estimated QP is larger than the target QP, the VBR derived QP will be used as the final QP for the encoding. Otherwise, the target QP will be used as the final QP for encoding of the current block.

In another implementation, a min QP may be derived from the target QP based on the difference between the target QP and the VBR derived estimated QP. In such an implementation, the VBR derived estimated QP may then be capped with the min QP derived from the target QP.

In operation, target bitrate and quality control subsystem 200 may perform rate control by utilizing target quality (in addition to the target bit rate) as another control parameter. Target quality can be an intelligent constant quality (ICQ) factor, which may be directly mapped to the quantization parameter that is defined by the video coding standard. For example, the ICQ factor can be in the range of 1 to 51 for HEVC and AVC, 1 to 127 for VP8 and 1 to 255 for VP9. Target quality can also be some subjective measurement such as perfect, very good, good, acceptable and poor.

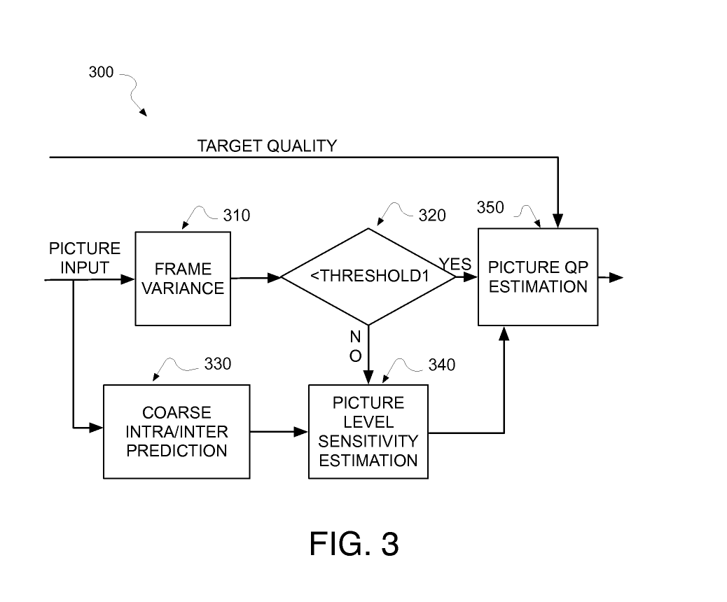

FIG. 3 is an illustrative diagram of an example quality oriented picture QP calculation portion of a target bitrate and quality control subsystem in accordance with at least some implementations of the present disclosure. In the illustrated implementation, system 100 of FIG. 1 may implement quality oriented picture QP calculation scheme 300.

In the illustrated implementation, quality oriented picture QP calculation scheme 300 may include one or more modules configured to determine a target QP at a picture level based at least in part on a target quality factor. For example, quality oriented picture QP calculation scheme 300 may include frame variance module 310, threshold module 320, coarse inter/intra prediction module 330, picture level sensitivity estimation module 340, and/or picture QP estimation module 350.

In some implementations, frame variance module 310 may be configured to determine a frame variance. For example, frame variance module 310 may determine a frame variance based at least in part on a received video analysis output.

In some implementations, threshold module 320 may be configured to perform a threshold determination. For example, threshold module 320 may perform a threshold determination based at least in part on the determined frame variance.

In some implementations, coarse inter/intra prediction module 330 may be configured to determine a prediction distortion value. For example, coarse inter/intra prediction module 330 may determine a prediction distortion value based at least in part on a coarse intra/inter prediction of the video analysis output. The coarse inter/intra prediction can be a fast inter/intra prediction applied on the down-sampled frames, which may be used to estimate the average prediction error, for example.

In some implementations, picture level sensitivity estimation module 340 may be configured to determine picture level sensitivity estimation. For example, picture level sensitivity estimation module 340 may determine a picture level sensitivity estimation based at least in part on the determined frame variance and on the determined prediction distortion when the threshold determination indicates that the determined frame variance is significant.

In some implementations, picture QP estimation module 350 may be configured to determine the target QP at a picture level. For example, picture QP estimation module 350 may determine the target QP at a picture level based at least in part on the received target quality factor as well as on the determined picture level sensitivity when the threshold determination indicates that the determined frame variance is not significant. Further, under other conditions, picture QP estimation module 350 may determine the target QP at a picture level based at least in part on the received target quality factor as well as on the determined frame variance when the threshold determination indicates that the determined frame variance is significant.

In operation, quality oriented picture QP calculation scheme 300 may utilize two example approaches. The first approach can be described in the block diagram of FIG. 3. In the beginning, the initial QP values may be estimated for each frame type. For AVC, the frame type can be Intra (I) frame, P frame, B frame and reference B frame, for example. For HEVC, the frame type is related to reference depth level when hierarchical coding structure is used, for example. The initial QP estimation may be applied as follows:

Initial_QP(I)=Function(target_quality) Eq. (1)

Initial_QP(P)=Initial_QP(I)+OffsetP(target_quality) Eq. (2)

Initial_QP(B)=Initial_QP(I)+OffsetB(target_quality) Eq. (3)

Where OffsetP( ) may be in the range of 0 to 4, the lower the ICQ factor is, the higher the value of OffsetP( ) may be. Where OffsetB( ) may be in the range of 2 to 8, the lower the ICQ factor is, the higher the value of OffsetB( ) may be.

For each input picture, the frame variance may be calculated. The frame variance can be calculated either based on whole frame or as the average of all the block variance within the frame. After the frame variance is obtained, the frame variance may be compared to a threshold. If the frame variance is less than the threshold, a delta QP may be derived as a function of frame variance, as follows:

Picture_Delta_QP=Function1(Frame_Variance) Eq. (4)

The Function1 derived Picture_Delta_QP may be in the range of 0 to 4, where the lower the Frame_Variance is, the higher the value of Picture_Delta_QP is.

If the frame variance is larger or equal to the threshold, a picture level sensitivity estimation may be conducted based on the frame variance and the prediction distortion, as follows:

Picture_Sensitivity=Function2(Frame_Variance)+Function3(Prediction_Distortion) Eq. (5)

A delta QP may then be derived as a function of picture sensitivity, as follows:

Picture_Delta_QP=Function4(Picture_Sensitivity) Eq. (6)

Where the Function4 derived Picture_Delta_QP may be in the range of −3 to 2, where the lower the Picture_{—} Sensitivity is, the lower the value of Picture_Delta_QP is.

With the derived Picture_Delta_QP, the picture level target QP may be calculated as follows:

Pic_Target_QP=Initial_QP−Picture_Delta_QP Eq. (7)

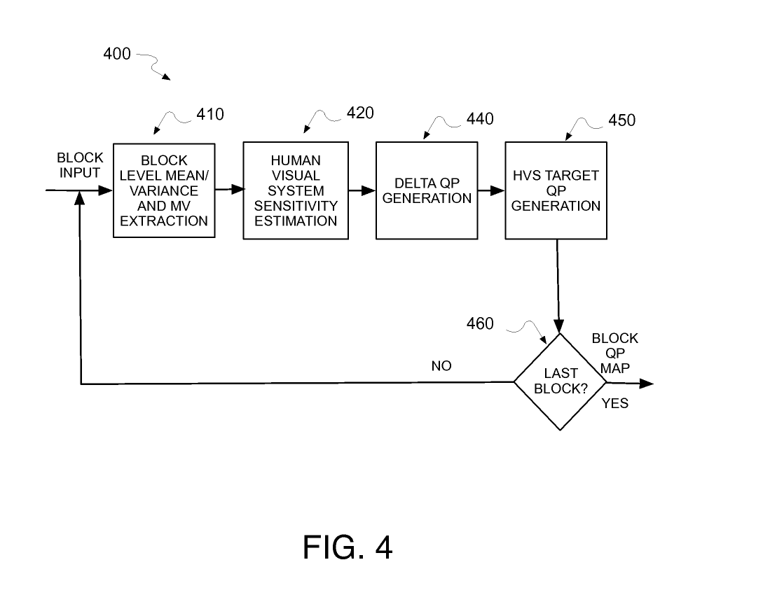

FIG. 4 is an illustrative diagram of an example HVS based block QP map generation portion of a target bitrate and quality control subsystem in accordance with at least some implementations of the present disclosure. In the illustrated implementation, system 100 of FIG. 1 may implement HVS based block QP map generation scheme 400.

In the illustrated implementation, HVS based block QP map generation scheme 400 may include one or more modules. For example, HVS based block QP map generation scheme 400 may include block level mean/variance and motion vector (MV) extraction module 410, human visual system (HVS) sensitivity estimation module 420, delta QP generation module 440, HVS target AP generation module 450, and/or a last block determination module 460.

In some implementations, block level mean/variance and motion vector extraction module 410 may be configured to determine an average pixel value for individual blocks. For example, block level mean/variance and motion vector extraction module 410 may determine an average pixel value for individual blocks by a mean value and a variance. Additionally, for the block in an inter frame, and estimated motion vector (MV) may also be extracted.

In some implementations, human visual system (HVS) sensitivity estimation module 420 may be configured to estimate a human sensitivity level of individual blocks based at least in part on one or more factors. For example, human visual system (HVS) sensitivity estimation module 420 may utilize one or more of the following factors: variations in relatively extreme dark and/or relatively extreme light areas, variation in relatively smooth areas, relative blurring in areas with relative fine texture, temporal variations of areas with relatively low motion, variations of relatively heavy texture areas, the like, and/or combinations thereof.

In some implementations, delta QP generation module 440 may be configured to determine a block level delta QP based at least in part on mapping the estimate human sensitivity level of individual blocks. For example, delta QP generation module 440 may map the estimated human sensitivity level of individual blocks where higher estimate human sensitivity levels are mapped to bigger delta QP values and lower estimated human sensitivity levels are mapped to smaller delta QP values.

In some implementations, HVS target QP generation module 450 may be configured to determine the target QP at a block level. For example, HVS target AP generation module 450 may determine the target QP at a block level based at least in part on the determined block level delta QP and the determined target QP at the picture level (e.g., as output from quality oriented picture QP calculation scheme 300 in FIG. 3).

In some implementations, last block determination module 460 may be configured to iterate through a given picture frame until the last block has been processed.

In operation, HVS based block QP map generation scheme 400 may be utilized to generate a block level QP map. For example, after the picture level target QP is obtained, the block QP map may be generated. The block diagram of FIG. 4 can describe the detailed process. First, for each block, the mean (e.g., average pixel value) and/or variance may be calculated in a first step. For a block in an interframe, an estimated motion vector may also be extracted.

In the second step, an HVS based sensitivity may be estimated based on the following principles: the human eye is less sensitive to the variations in the very dark or very bright areas; the human eye is sensitive to the variations in the smooth areas; the human eye is sensitive to the blurring in the areas with fine texture; the human eye is sensitive to the temporal variations of areas with less motion; and/or the human eye is less sensitive to the variations of heavy texture areas. In one example embodiment, the HVS based sensitivity may be divided into 10 levels with level zero as the least sensitive and level nine as the most sensitive.

In the third step, after the sensitive level is obtained, the sensitive level maybe mapped to a block delta QP. For example, higher levels may be mapped to bigger delta QP and lower levels may be mapped to smaller delta QP (e.g., delta QP might have a negative value). In one example embodiment, the delta QP may be in the range of −3 to 6 corresponding to the 10 example sensitivity levels.

In the fourth step, with the obtained picture level target QP and block delta QP, the target QP for the current block may be calculated, as follows:

Block_Target_QP=Pic_Target_QP−block_Delta_QP Eq. (8)

Where the above process may be continued until all the blocks are processed. For example, for AVC and VP8, the block size may be 16×16; for HEVC and VP9, the block size can be 8×8, 16×16 or 32×32 depend on the video resolution; for super HD as 4K×2K or 8K×4K, bigger block sizes can be selected; and/or for HD and below resolution, 16×16 or 8×8 might be preferred.

As an alternative method, the second approach can use the QP estimation method proposed in previous application Ser. No. 14/265,580 “CONSTANT QUALITY VIDEO CODING” filed 30 Apr. 2014, the disclosure of which is hereby expressly incorporated herein in its entirety.

In such an implementation, for example, the QP of each macroblock (MB) (e.g., each macroblock (MB) in AVC or CU (in HEVC)) may be adjusted based on its relative HVS sensitivity to the whole frame. In some examples, the frame level QP may adjusted to a smaller value for the block with high HVS sensitivity and the block with low HVS sensitivity may use a higher QP value. In one example, the block prediction distortion and its ratio with the frame average can be used to estimate the HVS sensitivity. Lower distortion and small ratio (less than 1) usually may represent a high HVS sensitivity. An example step by step procedure is described below for block level QP adjustment:

1. For intra frames, the distortion ratio of each block may be first calculated. If the ratio is greater than a threshold, the block may use frame level QP as its final QP. Otherwise, an offset value may be calculated based on the ratio value and the absolute distortion value. The offset may be from −1 to −6. That means that block in flat area can use QP that is up to 6 smaller than frame level QP.

2. For inter frames, if the current frame is a scene change frame, the frame may be treated as intra frame for block level QP adjustment.

3. Otherwise, if the ratio is greater than a threshold, a positive offset may be calculated based on the ratio and the motion vector value. For the block with high motion value and big distortion, the offset can be up to three, which means that block can use QP that is up to 3 smaller than frame level QP. If the ratio is greater than another threshold, a positive offset may be calculated based on the ratio, the absolute distortion, and the motion vector value. The offset may be from −1 to −4. That means that inter block in flat areas can use QP that is up to 4 smaller than frame level QP.

4. The above steps are repeated until the end of the frame.

As described above, a minQP can be derived from the Block_Target_QP and VBR_QP. The guideline to derive the minQP may be described, as follows:

If VBR_QP<Block_Target_QP and Offset1=Block_Target_QP−VBR_QP,minQP=Block_Target_QP−f(Offset1). In one example embodiment,Offset1=8 and f(Offset1)=Offset1/8 Eq. (9)

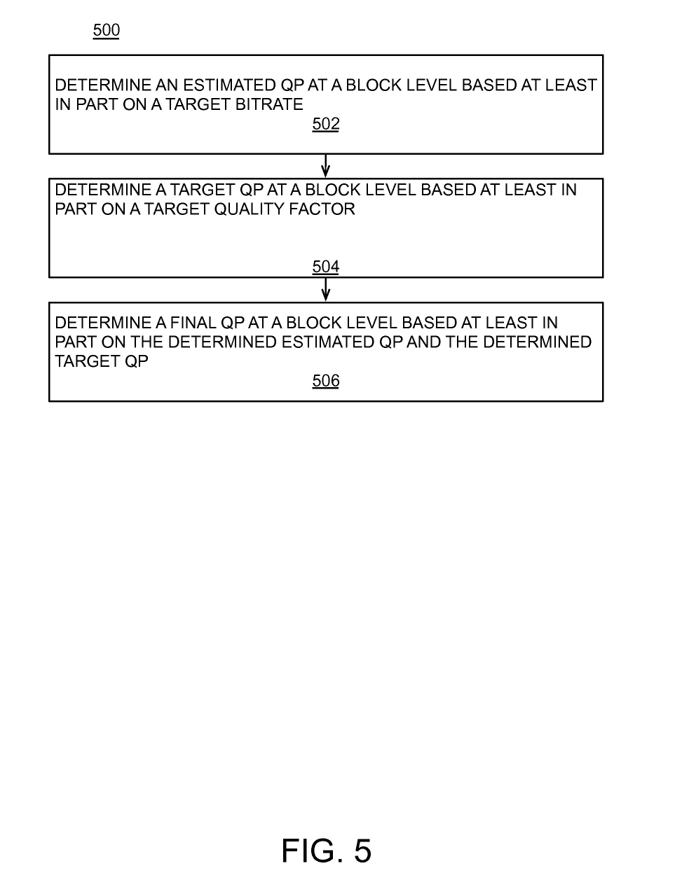

As will be discussed in greater detail below, video coding system 100 of FIG. 1, target bitrate and quality control subsystem 200 of FIG. 2, quality oriented picture QP calculation scheme 300 of FIG. 3, and/or HVS based block QP map generation scheme 400 of FIG. 4 may be used to perform some or all of the various functions discussed below in connection with FIGS. 5-8.

FIG. 5 is a flow diagram illustrating an example target bitrate and quality control coding process 500, arranged in accordance with at least some implementations of the present disclosure. Process 500 may include one or more operations, functions or actions as illustrated by one or more of operations 502, etc.

Process 500 may begin at operation 502, “DETERMINE AN ESTIMATED QP AT A BLOCK LEVEL BASED AT LEAST IN PART ON A TARGET BITRATE”, where an estimated QP may be determined. For example, an estimated QP may be determined at a block level based at least in part on a target bitrate.

Process 500 may continue at operation 504, “DETERMINE A TARGET QP AT A BLOCK LEVEL BASED AT LEAST IN PART ON A TARGET QUALITY FACTOR”, where, a target QP may be determined. For example, a target QP may be determined at a block level based at least in part on a target quality factor.

Process 500 may continue at operation 506, “DETERMINE A FINAL QP AT A BLOCK LEVEL BASED AT LEAST IN PART ON THE DETERMINED ESTIMATED QP AND THE DETERMINED TARGET QP”, where a final QP may be determined. For example, a final QP may be determined at a block level based at least in part on the determined estimated QP and the determined target QP.

Process 500 may provide for video coding, such as video encoding, decoding, and/or bitstream transmission techniques, which may be employed by a coder system as discussed herein.

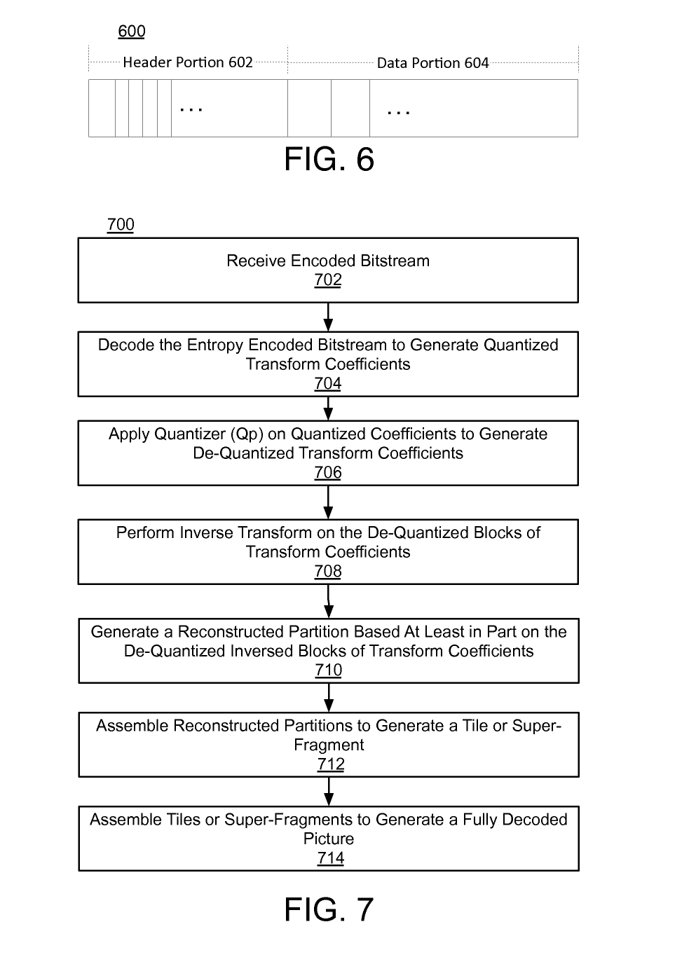

FIG. 6 illustrates an example bitstream 600, arranged in accordance with at least some implementations of the present disclosure. In some examples, bitstream 600 may correspond to bitstream 111 (see, e.g., as shown in FIG. 1) output from coder 100 and/or a corresponding input bitstream to a decoder. Although not shown in FIG. 6 for the sake of clarity of presentation, in some examples bitstream 600 may include a header portion 602 and a data portion 604. In various examples, bitstream 600 may include data, indicators, index values, mode selection data, or the like associated with encoding a video frame as discussed herein. As discussed, bitstream 600 may be generated by an encoder and/or received by a decoder for decoding such that decoded video frames may be presented via a display device.

FIG. 7 is a flow diagram illustrating an example decoding process 700, arranged in accordance with at least some implementations of the present disclosure. Process 700 may include one or more operations, functions or actions as illustrated by one or more of operations 702, etc. Process 700 may form at least part of a video coding process. By way of non-limiting example, process 700 may form at least part of a video decoding process as might be undertaken by the internal decoder loop of coder system 100 of FIG. 1 or a decoder system (not illustrated) of the same or similar design.

Process 700 may begin at operation 702, “Receive Encoded Bitstream”, where a bitstream of a video sequence may be received. For example, a bitstream encoded as discussed herein may be received at a video decoder.

Process 700 may continue at operation 704, “Decode the Entropy Encoded Bitstream to Generate Quantized Transform Coefficients”, where the bitstream may be decoded to generate quantized transform coefficients. In some examples, the decoded data may include to coding partition indicators, block size data, transform type data, quantizer (Qp), quantized transform coefficients, the like, and/or combinations thereof.

Process 700 may continue at operation 706, “Apply Quantizer (Qp) on Quantized Coefficients to Generate a De-Quantized Block of Transform Coefficients”, where a quantizer (Qp) may be applied to quantized transform coefficients to generate a de-quantized block of transform coefficients.

Process 700 may continue at operation 708, “Perform Inverse Transform On the De-Quantized Blocks of Transform Coefficients”, where, an inverse transform may be performed on each de-quantized block of transform coefficients. For example, performing the inverse transform may include an inverse transform process similar to or the same as the inverse of any forward transform used for encoding as discussed herein.

Process 700 may continue at operation 710, “Generate a Reconstructed Partition based at least in part on the De-Quantized and Inversed Blocks of Transform Coefficients”, where a reconstructed prediction partition may be generated based at least in part on the de-quantized and inversed block of transform coefficients. For example, a prediction partition may be added to the decoded prediction error data partition, which is represented by a given de-quantized and inversed block of transform coefficients, to generate a reconstructed prediction partition.

Process 700 may continue at operation 712, “Assemble Reconstructed Partitions to Generate a Tile or Super-Fragment”, where the reconstructed prediction partitions may be assembled to generate a tile or super-fragment. For example, the reconstructed prediction partitions may be assembled to generate tiles or super-fragments.

Process 700 may continue at operation 714, “Assemble Tiles or Super-Fragments Generate a Fully Decoded Picture”, where the tiles or super-fragments of a picture may be assembled (and/or further processed) to generate a fully decoded picture. For example, after optional filtering (e.g., deblock filtering, quality restoration filtering, and/or the like), tiles or super-fragments may be assembled to generate a full decoded picture, which may be stored via a decoded picture buffer (not shown) and/or transmitted for presentment via a display device after picture reorganization.

In operation, the de-quantization may be performed by de-quantization and inverse transform module 110 of FIG. 1, and/or by a similar or identical module in a decoder with structure corresponding to the internal decoder loop of coder system 100 of FIG. 1. Similarly, in some implementations, the inverse transform of Process 700 may be performed by de-quantization and inverse transform module 110 of FIG. 1, and/or by a similar or identical module in a decoder with structure corresponding to the internal decoder loop of coder system 100 of FIG. 1. Those skilled in the art may recognize that de-quantization is achieved by scaling and saturation of the quantized transform coefficients output by 704 in FIG. 7; the inverse transformation process acting on the de-quantized data may be similar to the forward transformation of 108 in operation but with a different transformation matrix.

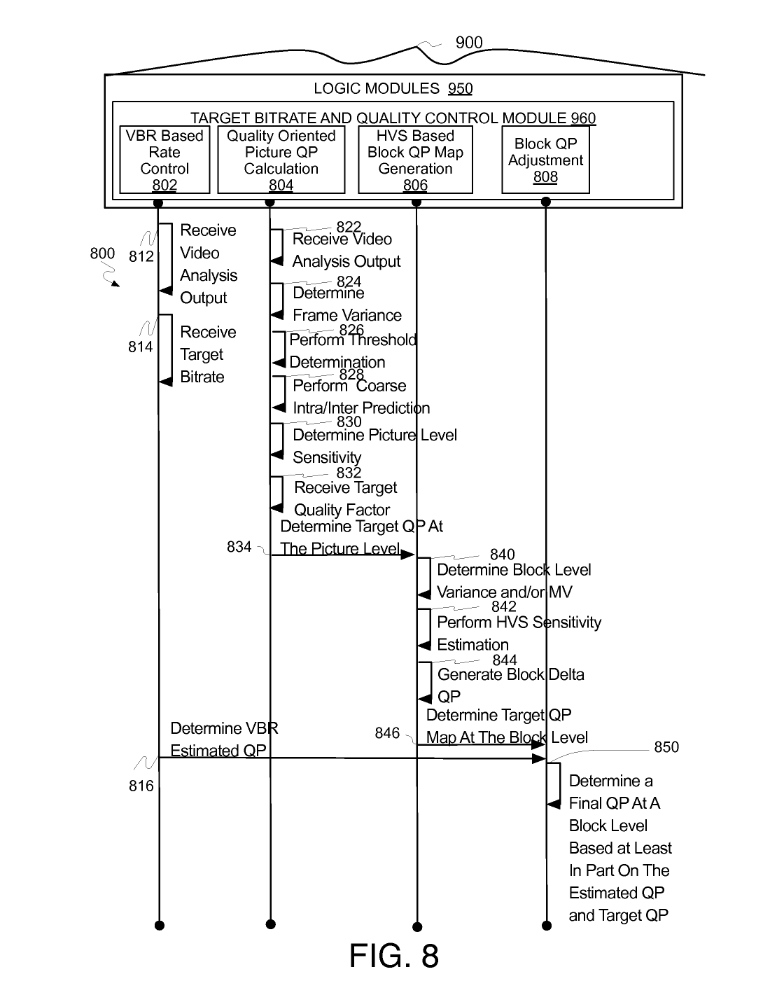

Some additional and/or alternative details related to process 500, 700 and other processes discussed herein may be illustrated in one or more examples of implementations discussed herein and, in particular, with respect to FIG. 8 below.

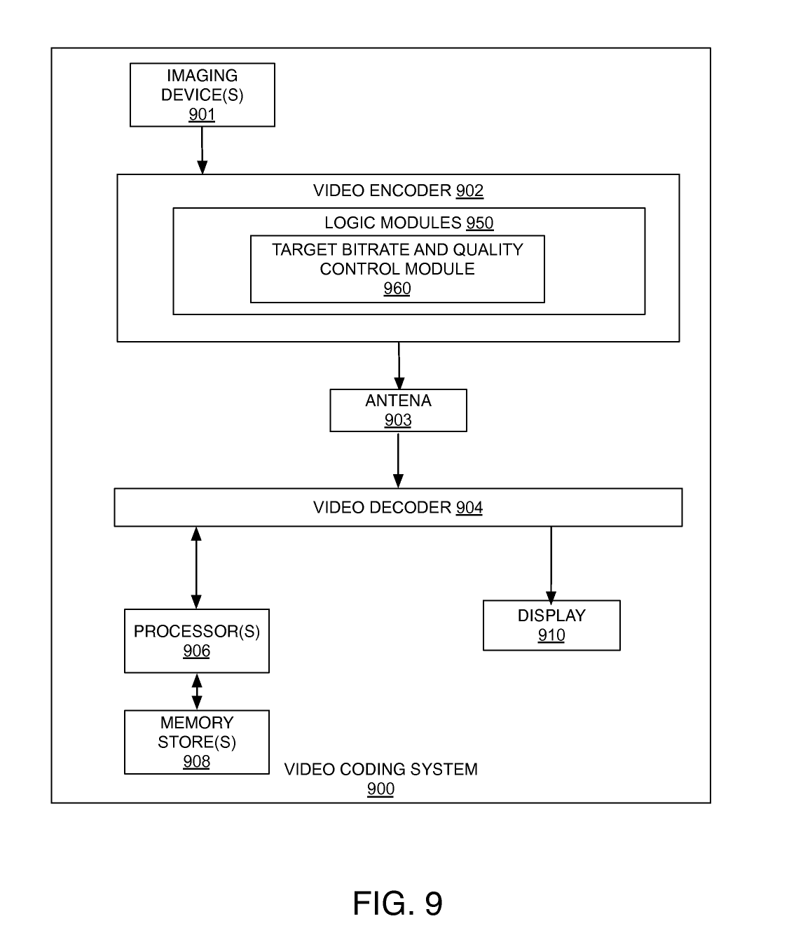

FIG. 8 provide an illustrative diagram of an example video coding system 900 (see, e.g., FIG. 9 for more details) and video coding process 800 in operation, arranged in accordance with at least some implementations of the present disclosure. In the illustrated implementation, process 800 may include one or more operations, functions or actions as illustrated by one or more of actions 812, etc.

By way of non-limiting example, process 800 will be described herein with reference to example video coding system 900 including coder 100 of FIG. 1, as is discussed further herein below with respect to FIG. 9. In various examples, process 800 may be undertaken by a system including both an encoder and decoder or by separate systems with one system employing an encoder (and optionally a decoder) and another system employing a decoder (and optionally an encoder). It is also noted, as discussed above, that an encoder may include a local decode loop employing a local decoder as a part of the encoder system.

As illustrated, video coding system 900 (see, e.g., FIG. 9 for more details) may include logic modules 950. For example, logic modules 950 may include any modules as discussed with respect to any of the coder systems or subsystems described herein. For example, logic modules 950 may include a transform and quantization logic module 960 and/or the like. For example, transform and quantization logic module 960 may be configured to perform rate control.

Process 800 may begin at operation 812, “Receive Video Analysis Output”, where a video analysis output may be received. For example, a video analysis output may be received via VBR based rate control module 802.

Process 800 may proceed from operation 812 to continue at operation 814, “Receive Target Bitrate”, where a target bitrate may be received. For example, a target bitrate may be received via VBR based rate control module 802.

Process 800 may proceed from operation 814 to continue at operation 816, “Determine VBR Estimated QP”, where an estimated QP may be determined. For example, an estimated QP may be determined at a block level based at least in part on the received target bitrate.

In some implementations, VBR based rate control module 802 may be configured to determine an estimated QP at a block level based at least in part on a target bitrate. For example, in the beginning of the encoding, video analysis may be conducted to provide necessary information for VBR based rate control. Based on the analysis, target bit rate, buffer fullness and instant encoding information; VBR rate control may generate an estimated QP for each coding block of the current frame. For VBR based rate control module 130, any method which is capable of achieving target bit rate and satisfying the buffer constraints can be used here.

In some implementations, some or all of operations 812-814 may be performed via VBR based rate control module 802.

In parallel with operations 812, 814 and/or 816, Process 800 may continue at operation 822, “Receive Video Analysis Output”, where a video analysis output may be received. For example, a video analysis output may be received via quality oriented picture QP calculation module 804.

Process 800 may proceed from operation 822 to continue at operation 824, “Determine Frame Variance”, where a frame variance may be determined. For example, a frame variance may be determined based at least in part on a received video analysis output.

Process 800 may proceed from operation 824 to continue at operation 826, “Perform Threshold Determination”, where a threshold determination may be performed. For example, a threshold determination may be performed based at least in part on the determined frame variance.

In parallel with operations 824 and 826, Process 800 may proceed from operation 822 to continue at operation 828, “Perform Coarse Intra/Inter Prediction”, where a coarse inter/intra prediction may be performed. For example, a prediction distortion value may be determined based at least in part on a coarse intra/inter prediction of the video analysis output.

Process 800 may proceed from operation 828 to continue at operation 830, “Determine Picture Level Sensitivity”, where picture level sensitivity may be determined. For example, a picture level sensitivity may be determined based at least in part on the determined frame variance and on the determined prediction distortion when the threshold determination indicates that the determined frame variance is significant.

Process 800 may continue at operation 832, “Receive Target Quality Factor”, where a target quality factor may be received. For example, a target quality factor may be received via quality oriented picture QP calculation module 804.

Process 800 may proceed from operation 826 and/or 830 to continue at operation 834, “Determine Target QP At The Picture Level”, where a target QP at a picture level may be determined. For example, a target QP at a picture level may be determined based at least in part on the received target quality factor as well as on the determined picture level sensitivity when the threshold determination indicates that the determined frame variance is not significant. Further, under other conditions, the target QP at a picture level may be determined based at least in part on the received target quality factor as well as on the determined frame variance when the threshold determination indicates that the determined frame variance is significant.

In some implementations, quality oriented picture QP calculation module 804 may be configured to determine a target QP at a picture level based at least in part on a target quality factor. For example, at the same time of VBR rate control process, a target picture level QP may be derived in quality oriented picture QP calculation module 140 based on video analysis information and target quality.

In some implementations, some or all of operations 822-834 may be performed via quality oriented picture QP calculation module 804.

Process 800 may continue at operation 840, “Determine Block Level Variance and/or MV”, where a block level variance and/or motion vector (MV) may be determined. For example an average pixel value for individual blocks may be determined by a mean value and a variance. Additionally, for the block in an inter frame, and estimated motion vector (MV) may also be extracted

Process 800 may continue at operation 842, “Perform HVS Sensitivity Estimation”, where a human sensitivity level estimation may be performed. For example, a human sensitivity level estimation may be performed on individual blocks based at least in part on one or more of the following factors: variations in relatively extreme dark and/or relatively extreme light areas, variation in relatively smooth areas, relative blurring in areas with relative fine texture, temporal variations of areas with relatively low motion, variations of relatively heavy texture areas, the like, and/or combinations thereof.

Process 800 may continue at operation 844, “Generate Block Delta QP”, where a block level delta QP may be generated. For example, where a block level delta QP may be determined based at least in part on mapping the estimated human sensitivity level of individual blocks where higher estimate human sensitivity levels are mapped to bigger delta QP values and lower estimated human sensitivity levels are mapped to smaller delta QP values.

Process 800 may continue at operation 846, “Determine Target QP Map At The Block Level”, where a target QP at a block level may be determined. For example, a target QP at a block level may be determined based at least in part on the determined block level delta QP and the determined target QP at the picture level (e.g., as output from quality oriented picture QP calculation module 804 at operation 834).

In some implementations, some or all of operations 840-846 may be performed via HVS based block QP map generation module 806.

In some implementations, HVS based block QP map generation module 806 may be configured to determine a target QP at a block level based at least in part on a target quality factor (e.g., as a refinement of the determined coarse target QP at a picture level). For example, on top of the target picture level QP, block QP map is generated according to the HVS based analysis to provide a target QP at a block level (e.g., a target QP for each coding block).

Process 800 may continue at operation 850, “Determine a Final QP At A Block Level Based at Least In Part On The Estimated QP and Target QP”, where a final QP at a block level may be determined. For example, a final QP at a block level may be determined based at least in part on the estimated QP and the determined target QP.

In some implementations, block QP adjustment module 808 may determine a final QP at a block level based at least in part on the estimated QP and the determined target QP. For example, after the block QP map is generated, the VBR derived QP is adjusted according to the target QP for each block. The adjusted final QP will be sent to the encoder and used for the mode decision and final quantization process.

In one implementation, the VBR derived estimated QP may be lower capped by the target QP. That means if the VBR derived estimated QP is larger than the target QP, the VBR derived QP will be used as the final QP for the encoding. Otherwise, the target QP will be used as the final QP for encoding of the current block.

In another implementation, a min QP may be derived from the target QP based on the difference between the target QP and the VBR derived estimated QP. In such an implementation, the VBR derived estimated QP may then be capped with the min QP derived from the target QP.

In some implementations, some or all of operation 850 and/or the like may be performed via block QP adjustment module 808.

In operation, process 800 may perform rate control by utilizing target quality (in addition to the target bit rate) as another control parameter. Target quality can be an intelligent constant quality (ICQ) factor, which may be directly mapped to the quantization parameter that is defined by the relevant video coding standard.

Although process 800, as illustrated, is directed to coding, the concepts and/or operations described may be applied to encoding and/or decoding separately, and, more generally, to video coding.

While implementation of the example processes herein may include the undertaking of all operations shown in the order illustrated, the present disclosure is not limited in this regard and, in various examples, implementation of the example processes herein may include the undertaking of only a subset of the operations shown and/or in a different order than illustrated. Additionally, although one particular set of blocks or actions is illustrated as being associated with particular modules, these blocks or actions may be associated with different modules than the particular modules illustrated here.

Various components of the systems and/or processes described herein may be implemented in software, firmware, and/or hardware and/or any combination thereof. For example, various components of the systems and/or processes described herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures.

As used in any implementation described herein, the term “module” may refer to a “component” or to a “logic unit”, as these terms are described below. Accordingly, the term “module” may refer to any combination of software logic, firmware logic, and/or hardware logic configured to provide the functionality described herein. For example, one of ordinary skill in the art will appreciate that operations performed by hardware and/or firmware may alternatively be implemented via a software component, which may be embodied as a software package, code and/or instruction set, and also appreciate that a logic unit may also utilize a portion of software to implement its functionality.

As used in any implementation described herein, the term “component” refers to any combination of software logic and/or firmware logic configured to provide the functionality described herein. The software logic may be embodied as a software package, code and/or instruction set, and/or firmware that stores instructions executed by programmable circuitry. The components may, collectively or individually, be embodied for implementation as part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the systems discussed herein. Further, one of ordinary skill in the art will appreciate that operations performed by hardware and/or firmware may also utilize a portion of software to implement the functionality of the logic unit.

In addition, any one or more of the blocks of the processes described herein may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5, 7, and 8 in response to instructions conveyed to the processor by a computer readable medium.

FIG. 9 is an illustrative diagram of example video coding system 900, arranged in accordance with at least some implementations of the present disclosure. In the illustrated implementation, video coding system 900, although illustrated with both video encoder 902 and video decoder 904, video coding system 900 may include only video encoder 902 or only video decoder 904 in various examples. Video coding system 900 (which may include only video encoder 902 or only video decoder 904 in various examples) may include imaging device(s) 901, an antenna 902, one or more processor(s) 906, one or more memory store(s) 908, and/or a display device 910. As illustrated, imaging device(s) 901, antenna 902, video encoder 902, video decoder 904, processor(s) 906, memory store(s) 908, and/or display device 910 may be capable of communication with one another.

In some implementations, video coding system 900 may include antenna 903. For example, antenna 903 may be configured to transmit or receive an encoded bitstream of video data, for example. Processor(s) 906 may be any type of processor and/or processing unit. For example, processor(s) 906 may include distinct central processing units, distinct graphic processing units, integrated system-on-a-chip (SoC) architectures, the like, and/or combinations thereof. In addition, memory store(s) 908 may be any type of memory. For example, memory store(s) 908 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 908 may be implemented by cache memory. Further, in some implementations, video coding system 900 may include display device 910. Display device 910 may be configured to present video data.

As shown, in some examples, video coding system 900 may include logic modules 950. While illustrated as being associated with video encoder 902, video decoder 904 may similarly be associated with identical and/or similar logic modules as the illustrated logic modules 950. Accordingly, video encoder 902 may include all or portions of logic modules 950. For example, antenna 903, video decoder 904, processor(s) 906, memory store(s) 908, and/or display 910 may be capable of communication with one another and/or communication with portions of logic modules 950. Similarly, video decoder 904 may include identical and/or similar logic modules to logic modules 950. For example, imaging device(s) 901 and video decoder 904 may be capable of communication with one another and/or communication with logic modules that are identical and/or similar to logic modules 950.

In some implementations, logic modules 950 may embody various modules as discussed with respect to any system or subsystem described herein. For example, logic modules 950 may include a transform and quantization logic module 960 and/or the like. For example, transform and quantization logic module 960 may include a rate control module logic module configured to determine an estimated QP at a block level based at least in part on a target bitrate; a human visual system based block QP Map generation module configured to determine a target QP at a block level based at least in part on a target quality factor; and/or a block QP adjustment module configured to determine a final QP at a block level based at least in part on the determined estimated QP and the determined target QP.

In various embodiments, some of logic modules 950 may be implemented in hardware, while software may implement other logic modules. For example, in some embodiments, some of logic modules 950 may be implemented by application-specific integrated circuit (ASIC) logic while other logic modules may be provided by software instructions executed by logic such as processors 906. However, the present disclosure is not limited in this regard and some of logic modules 950 may be implemented by any combination of hardware, firmware and/or software.

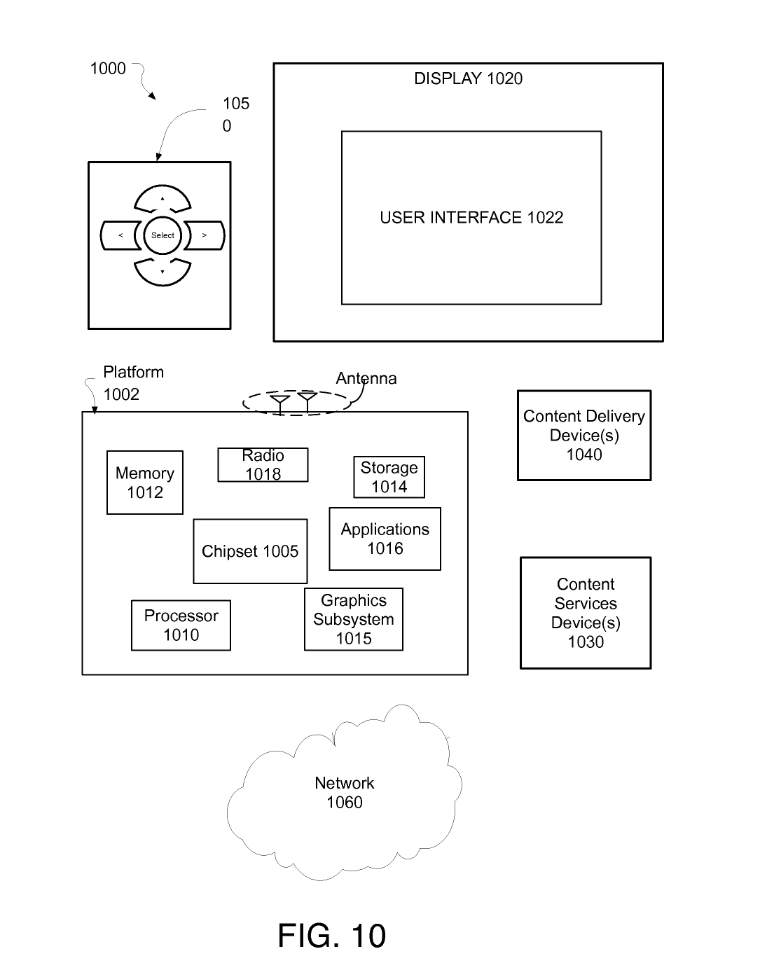

FIG. 10 is an illustrative diagram of an example system 1000, arranged in accordance with at least some implementations of the present disclosure. In various implementations, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1000 includes a platform 1002 coupled to a display 1020. Platform 1002 may receive content from a content device such as content services device(s) 1030 or content delivery device(s) 1040 or other similar content sources. A navigation controller 1050 including one or more navigation features may be used to interact with, for example, platform 1002 and/or display 1020. Each of these components is described in greater detail below.

In various implementations, platform 1002 may include any combination of a chipset 1005, processor 1010, memory 1012, antenna 1013, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1010 may be dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPU) or a visual processing unit (VPU), for example. An analog or digital interface may be used to communicatively couple graphics subsystem 1015 and display 1020. For example, the interface may be any of a High-Definition Multimedia Interface, DisplayPort, wireless HDMI, and/or wireless HD compliant techniques. Graphics subsystem 1015 may be integrated into processor 1010 or chipset 1005. In some implementations, graphics subsystem 1015 may be a stand-alone device communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television type monitor or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In various implementations, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In various implementations, content services device(s) 1030 may include a cable television box, personal computer, network, telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In various embodiments, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be replicated on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022. In various embodiments, controller 1050 may not be a separate component but may be integrated into platform 1002 and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 even when the platform is turned “off” In addition, chipset 1005 may include hardware and/or software support for (5.1) surround sound audio and/or high definition (7.1) surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 may be an integrated unit. Display 1020 and content service device(s) 1030 may be integrated, or display 1020 and content delivery device(s) 1040 may be integrated, for example. These examples are not meant to limit the present disclosure.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

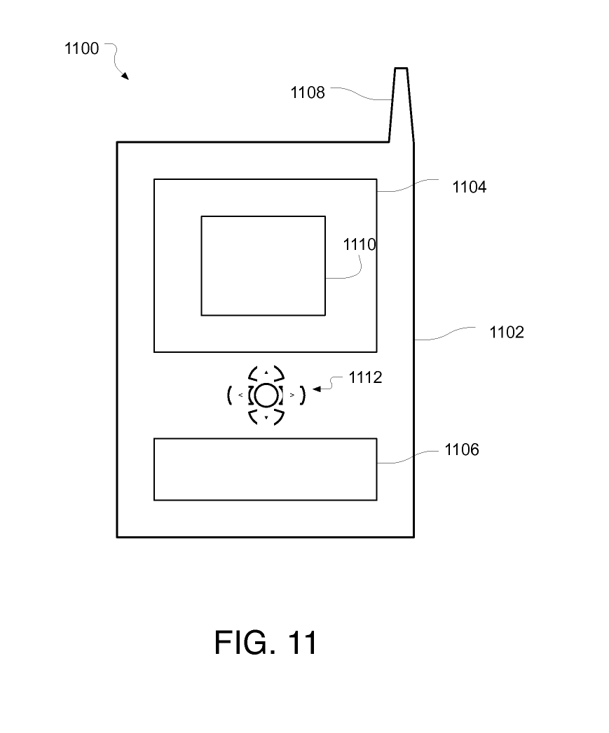

As described above, system 1000 may be embodied in varying physical styles or form factors. FIG. 11 illustrates implementations of a small form factor device 1100 in which system 1100 may be embodied. In various embodiments, for example, device 1100 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 1100 may include a housing 1102, a display 1104 which may include a user interface 1110, an input/output (I/O) device 1106, and an antenna 1108. Device 1100 also may include navigation features 1112. Display 1104 may include any suitable display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, image sensors, and so forth. Information also may be entered into device 1100 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the systems as discussed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one implementation, a computer-implemented method for video coding may include a target bitrate and quality control scheme. The target bitrate and quality control scheme may determine, via a rate control module, an estimated QP at a block level based at least in part on a target bitrate. A human visual system based block QP Map generation module may determine a target QP at a block level based at least in part on a target quality factor. A block QP adjustment module may determine a final QP at a block level based at least in part on the determined estimated QP and the determined target QP.

For example, a computer-implemented method for video coding may further include determining, via a quality oriented picture QP calculation module, a target QP at a picture level based at least in part on a target quality factor, the determination of the target QP at a picture level further comprising: receiving video analysis output. A frame variance may be determined based at least in part on a video analysis output. A threshold determination may be performed based at least in part on the determined frame variance. A prediction distortion value may be determined based at least in part on a coarse intra/inter prediction of the video analysis output. A picture level sensitivity may be determined based at least in part on the determined frame variance and on the determined prediction distortion when the threshold determination indicates that the determined frame variance is significant. The target quality factor may be received. The target QP may be determined at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant. The determination of the target QP at a block level is based at least in part on a target quality factor as a refinement of the determined coarse target QP at a picture level, where the determination of the target QP at a block level further comprises: determining an average pixel value and/or motion vector may be determined for individual blocks. A human sensitivity level of individual blocks may be estimated based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas, the like, and/or combinations thereof. A block level delta QP may be determined based at least in part on mapping the estimate human sensitivity level of individual blocks, where higher estimate human sensitivity levels are mapped to bigger delta QP values and lower estimated human sensitivity levels are mapped to smaller delta QP values. The target QP may be determined at a block level based at least in part on the determined block level delta QP and the determined target QP at the picture level. When the estimated QP is larger than the target QP, the estimated QP will be used as the final QP for the encoding; otherwise, the target QP will be used as the final QP for encoding of the current block. Additionally or alternatively, a min QP may be derived from the target QP based at least in part on the difference between the target QP and the estimated QP, where the estimated QP capped by the min QP will be used as the final QP for the encoding.

In other examples, a system for video coding on a computer may include a display device, one or more processors, one or more memory stores, one or more logic modules, the like, and/or combinations thereof. The display device may be configured to present video data. The one or more processors may be communicatively coupled to the display device. The one or more memory stores may be communicatively coupled to the one or more processors. The logic modules may include a rate control module logic module of a video coder communicatively coupled to the one or more processors and configured to: determine an estimated QP at a block level based at least in part on a target bitrate. A human visual system based block QP Map generation module may be communicatively coupled to a block QP adjustment module and configured to determine a target QP at a block level based at least in part on a target quality factor. The block QP adjustment module may be communicatively coupled to the rate control module and configured to determine a final QP at a block level based at least in part on the determined estimated QP and the determined target QP.

For example, the system for video coding on a computer may further include: a quality oriented picture QP calculation module configured to determine a target QP at a picture level based at least in part on a target quality factor, the determination of the target QP at a picture level further comprising: receiving video analysis output. A frame variance may be determined based at least in part on a video analysis output. A threshold determination may be performed based at least in part on the determined frame variance. A prediction distortion value may be determined based at least in part on a coarse intra/inter prediction of the video analysis output. A picture level sensitivity may be determined based at least in part on the determined frame variance and on the determined prediction distortion when the threshold determination indicates that the determined frame variance is significant. The target quality factor may be received. The target QP may be determined at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant. The determination of the target QP at a block level is based at least in part on a target quality factor as a refinement of the determined coarse target QP at a picture level, where the determination of the target QP at a block level further comprises: determining an average pixel value and/or motion vector may be determined for individual blocks. A human sensitivity level of individual blocks may be estimated based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas, the like, and/or combinations thereof. A block level delta QP may be determined based at least in part on mapping the estimate human sensitivity level of individual blocks, where higher estimate human sensitivity levels are mapped to bigger delta QP values and lower estimated human sensitivity levels are mapped to smaller delta QP values. The target QP may be determined at a block level based at least in part on the determined block level delta QP and the determined target QP at the picture level. When the estimated QP is larger than the target QP, the estimated QP will be used as the final QP for the encoding; otherwise, the target QP will be used as the final QP for encoding of the current block. Additionally or alternatively, a min QP may be derived from the target QP based at least in part on the difference between the target QP and the estimated QP, where the estimated QP capped by the min QP will be used as the final QP for the encoding.

In a further implementation, at least one machine readable medium may include a plurality of instructions that in response to being executed on a computing device, causes the computing device to perform the method according to any one of the above examples.

In a still further implementation, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed:

1. A computer-implemented method for video coding, comprising:
determining, via a rate control module, an estimated QP at a block level based at least in part on a target bitrate;
determining, via a human visual system based block QP Map generation module, a target QP at a block level based at least in part on a target quality factor; and
determining, via a block QP adjustment module, a final QP at a block level based at least in part on the determined estimated QP and the determined target QP.

2. The method of claim 1, further comprising:
determining, via a quality oriented picture QP calculation module and prior to the determination of the target QP at a block level, a target QP at a picture level based at least in part on a target quality factor.

3. The method of claim 1, further comprising:
determining, via a quality oriented picture QP calculation module, a target QP at a picture level based at least in part on a target quality factor, the determination of the target QP at a picture level further comprising:
receiving video analysis output;
determining a frame variance based at least in part on a video analysis output;
performing a threshold determination based at least in part on the determined frame variance;
determining a prediction distortion value based at least in part on a coarse intra/inter prediction of the video analysis output;
determining a picture level sensitivity based at least in part on the determined frame variance and on the determined prediction distortion when the threshold determination indicates that the determined frame variance is significant;
receiving the target quality factor; and
determining the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant.

4. The method of claim 1, further comprising:
determining, via a quality oriented picture QP calculation module, a target QP at a picture level based at least in part on a target quality factor; and
wherein the determination of the target QP at a block level is based at least in part on a target quality factor as a refinement of the determined coarse target QP at a picture level.

5. The method of claim 1, further comprising:
determining, via a quality oriented picture QP calculation module, a target QP at a picture level based at least in part on a target quality factor; and
wherein the determination of the target QP at a block level is based at least in part on a target quality factor as a refinement of the determined coarse target QP at a picture level, wherein the determination of the target QP at a block level further comprises:
determining an average pixel value and/or motion vector for individual blocks;
estimating a human sensitivity level of individual blocks;
determining a block level delta QP based at least in part on mapping the estimate human sensitivity level of individual blocks; and
determining the target QP at a block level based at least in part on the determined block level delta QP and the determined target QP at the picture level.

6. The method of claim 1, further comprising:
determining, via a quality oriented picture QP calculation module, a target QP at a picture level based at least in part on a target quality factor; and
wherein the determination of the target QP at a block level is based at least in part on a target quality factor as a refinement of the determined coarse target QP at a picture level, wherein the determination of the target QP at a block level further comprises:
determining an average pixel value and/or motion vector for individual blocks;
estimating a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determining a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determining the target QP at a block level based at least in part on the determined block level delta QP and the determined target QP at the picture level.

7. The method of claim 1, wherein when the estimated QP is larger than the target QP, the estimated QP will be used as the final QP for the encoding; otherwise, the target QP will be used as the final QP for encoding of the current block.

8. The method of claim 1, further comprising:
deriving a min QP from the target QP based at least in part on the difference between the target QP and the estimated QP, where the estimated QP capped by the min QP will be used as the final QP for the encoding.

9. The method of claim 1, further comprising:
determining, via a quality oriented picture QP calculation module, a target QP at a picture level based at least in part on a target quality factor, the determination of the target QP at a picture level further comprising:
receiving video analysis output;
determining a frame variance based at least in part on a video analysis output;
performing a threshold determination based at least in part on the determined frame variance;
determining a prediction distortion value based at least in part on a coarse intra/inter prediction of the video analysis output;
determining a picture level sensitivity based at least in part on the determined frame variance and on the determined prediction distortion when the threshold determination indicates that the determined frame variance is significant;
receiving the target quality factor; and
determining the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determining an average pixel value and/or motion vector for individual blocks;
estimating a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determining a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determining the target QP at a block level based at least in part on the determined block level delta QP and the determined target QP at the picture level,
wherein when the estimated QP is larger than the target QP, the estimated QP will be used as the final QP for the encoding; otherwise, the target QP will be used as the final QP for encoding of the current block.

10. The method of claim 1, further comprising:
determining, via a quality oriented picture QP calculation module, a target QP at a picture level based at least in part on a target quality factor, the determination of the target QP at a picture level further comprising:
receiving video analysis output;
determining a frame variance based at least in part on a video analysis output;
performing a threshold determination based at least in part on the determined frame variance;
determining a prediction distortion value based at least in part on a coarse intra/inter prediction of the video analysis output;
determining a picture level sensitivity based at least in part on the determined frame variance and on the determined prediction distortion when the threshold determination indicates that the determined frame variance is significant;
receiving the target quality factor; and
determining the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determining an average pixel value and/or motion vector for individual blocks;
estimating a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determining a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determining the target QP at a block level based at least in part on the determined block level delta QP and the determined target QP at the picture level; and
deriving a min QP from the target QP based at least in part on the difference between the target QP and the estimated QP, where the estimated QP capped by the min QP will be used as the final QP for the encoding.

11. A system for video coding on a computer, comprising:
a display device configured to present video data;
one or more processors communicatively coupled to the display device;
one or more memory stores communicatively coupled to the one or more processors;
a rate control module logic module of a video coder communicatively coupled to the one or more processors and configured to: determine an estimated QP at a block level based at least in part on a target bitrate;
a human visual system based block QP Map generation module communicatively coupled to a block QP adjustment module and configured to determine a target QP at a block level based at least in part on a target quality factor; and
the block QP adjustment module communicatively coupled to the rate control module and configured to determine a final QP at a block level based at least in part on the determined estimated QP and the determined target QP.

12. The system of claim 11, further comprising:
a quality oriented picture QP calculation module configured to: determine, prior to the determination of the target QP at a block level, a target QP at a picture level based at least in part on a target quality factor.

13. The system of claim 11, further comprising:
a quality oriented picture QP calculation module configured to: determine a target QP at a picture level based at least in part on a target quality factor, the determination of the target QP at a picture level further comprising:
receive video analysis output;
determine a frame variance based at least in part on a video analysis output;
perform a threshold determination based at least in part on the determined frame variance;
determine a prediction distortion value based at least in part on a coarse intra/inter prediction of the video analysis output;
determine a picture level sensitivity based at least in part on the determined frame variance and on the determined prediction distortion when the threshold determination indicates that the determined frame variance is significant;
receive the target quality factor; and
determine the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant.

14. The system of claim 11, further comprising:
a quality oriented picture QP calculation module configured to: determine a target QP at a picture level based at least in part on a target quality factor; and
wherein the determination of the target QP at a block level is based at least in part on a target quality factor as a refinement of the determined coarse target QP at a picture level.

15. The system of claim 11, further comprising:
a quality oriented picture QP calculation module configured to: determine a target QP at a picture level based at least in part on a target quality factor; and
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks;
determine a block level delta QP based at least in part on mapping the estimate human sensitivity level of individual blocks; and
determine the target QP at a block level based at least in part on the determined block level delta QP and the determined target QP at the picture level.

16. The system of claim 11, further comprising:
a quality oriented picture QP calculation module configured to: determine a target QP at a picture level based at least in part on a target quality factor; and
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determine a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determine the target QP at a block level based at least in part on the determined block level delta QP and the determined target QP at the picture level.

17. The system of claim 11, wherein when the estimated QP is larger than the target QP, the estimated QP will be used as the final QP for the encoding; otherwise, the target QP will be used as the final QP for encoding of the current block.

18. The system of claim 11, wherein the block QP adjustment module is further configured to determine the final QP based at least in part on a min QP derived from the target QP based at least in part on the difference between the target QP and the estimated QP, where the estimated QP capped by the min QP will be used as the final QP for the encoding.

19. The system of claim 11, further comprising:
a quality oriented picture QP calculation module configured to: determine a target QP at a picture level based at least in part on a target quality factor, the determination of the target QP at a picture level further comprising:
receive video analysis output;
determine a frame variance based at least in part on a video analysis output;
perform a threshold determination based at least in part on the determined frame variance;
determine a prediction distortion value based at least in part on a coarse intra/inter prediction of the video analysis output;
determine a picture level sensitivity based at least in part on the determined frame variance and on the determined prediction distortion when the threshold determination indicates that the determined frame variance is significant;
receive the target quality factor; and
determine the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determine a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determine the target QP at a block level based at least in part on the determined block level delta QP and the determined target QP at the picture level,
wherein when the estimated QP is larger than the target QP, the estimated QP will be used as the final QP for the encoding; otherwise, the target QP will be used as the final QP for encoding of the current block.

20. The system of claim 11, further comprising:
a quality oriented picture QP calculation module configured to: determine a target QP at a picture level based at least in part on a target quality factor, the determination of the target QP at a picture level further comprising:
receive video analysis output;
determine a frame variance based at least in part on a video analysis output;
perform a threshold determination based at least in part on the determined frame variance;
determine a prediction distortion value based at least in part on a coarse intra/inter prediction of the video analysis output;
determine a picture level sensitivity based at least in part on the determined frame variance and on the determined prediction distortion when the threshold determination indicates that the determined frame variance is significant;
receive the target quality factor; and
determine the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determine a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determine the target QP at a block level based at least in part on the determined block level delta QP and the determined target QP at the picture level,
wherein the block QP adjustment module is further configured to determine the final QP based at least in part on a min QP derived from the target QP based at least in part on the difference between the target QP and the estimated QP, where the estimated QP capped by the min QP will be used as the final QP for the encoding.

21. At least one machine readable medium comprising: a plurality of instructions that in response to being executed on a computing device, causes the computing device to perform:
determine an estimated QP at a block level based at least in part on a target bitrate;
determine a target QP at a block level based at least in part on a target quality factor; and
determine a final QP at a block level based at least in part on the determined estimated QP and the determined target QP.

22. The at least one machine readable medium method of claim 21, further comprising:
determine a target QP at a picture level based at least in part on a target quality factor, the determination of the target QP at a picture level further comprising:
receive video analysis output;
determine a frame variance based at least in part on a video analysis output;
perform a threshold determination based at least in part on the determined frame variance;
determine a prediction distortion value based at least in part on a coarse intra/inter prediction of the video analysis output;
determine a picture level sensitivity based at least in part on the determined frame variance and on the determined prediction distortion when the threshold determination indicates that the determined frame variance is significant;
receive the target quality factor; and
determine the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determine a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determine the target QP at a block level based at least in part on the determined block level delta QP and the determined target QP at the picture level,
wherein when the estimated QP is larger than the target QP, the estimated QP will be used as the final QP for the encoding; otherwise, the target QP will be used as the final QP for encoding of the current block.

23. The at least one machine readable medium method of claim 21, further comprising:
determine a target QP at a picture level based at least in part on a target quality factor, the determination of the target QP at a picture level further comprising:
receive video analysis output;
determine a frame variance based at least in part on a video analysis output;
perform a threshold determination based at least in part on the determined frame variance;
determine a prediction distortion value based at least in part on a coarse intra/inter prediction of the video analysis output;
determine a picture level sensitivity based at least in part on the determined frame variance and on the determined prediction distortion when the threshold determination indicates that the determined frame variance is significant;
receive the target quality factor; and
determine the target QP at a picture level based at least in part on the target quality factor as well as on the determined picture level sensitivity when the threshold determination indicates that the determined frame variance is not significant, and determining the target QP at a picture level based at least in part on the target quality factor as well as on the determined frame variance when the threshold determination indicates that the determined frame variance is significant;
wherein the determination of the target QP at a block level is based at least in part on a target quality factor as a refinement of the determined coarse target QP at a picture level, wherein the determination of the target QP at a block level further comprises:
determine an average pixel value and/or motion vector for individual blocks;
estimate a human sensitivity level of individual blocks based at least in part on one or more of the following factors: variations in relatively extreme dark and/or relatively extreme light areas, variation in relatively smooth areas, relative blurring in areas with relative fine texture, temporal variations of areas with relatively low motion, and/or variations of relatively heavy texture areas;
determine a block level delta QP based at least in part on mapping the estimate human sensitivity level of individual blocks, wherein higher estimate human sensitivity levels are mapped to bigger delta QP values and lower estimated human sensitivity levels are mapped to smaller delta QP values; and
determine the target QP at a block level based at least in part on the determined block level delta QP and the determined target QP at the picture level,
derive a min QP from the target QP based at least in part on the difference between the target QP and the estimated QP, where the estimated QP capped by the min QP will be used as the final QP for the encoding.
